(19) United States
(12) Patent Application Publication
(10) Pub. No.: US 2015/0127450 A1
(43) Pub. Date: May 7, 2015

(54) METHOD AND SYSTEM FOR AUTOMATED DETECTION OF CAN-SPAM VIOLATIONS BY MERCHANTS AND ACQUIRERS

(71) Applicant: MasterCard International Incorporated, Purchase, NY (US)

(72) Inventor: Justin Xavier Howe, Oakdale, NY (US)

(73) Assignee: MasterCard International Incorporated, Purchase, NY (US)

(21) Appl. No.: 14/071,775

(22) Filed: Nov. 5, 2013

(51) Int. Cl. G06Q 30/02

(52) U.S. Cl. CPC G06Q 30/0248
USPC 705/14.47

(57) ABSTRACT

A method for associating a merchant account with violating activity includes: storing a plurality of merchant profiles, each profile including at least a merchant identifier; receiving a uniform resource locator or hyperlink captured from distributed electronic content that is identified as being in violation of a rule or regulation; navigating, via a browsing application program, to a webpage via the received uniform resource locator or hyperlink; initiating a payment transaction for the purchase of goods or services via the webpage; receiving an authorization request for the payment transaction, wherein the authorization request includes at least a merchant identification; transmit an authorization response in response to the received authorization request; identifying, in the database, a specific merchant profile where the included merchant identifier corresponds to the merchant identification; and indicating, in the database, the specific merchant profile as being in violation of the rule or regulation.

### FIELD

The present disclosure relates to the associating of a merchant account with violating activity, specifically the use of transaction authorizations in conjunction with spam data to identify merchants or acquirers who may be in violation of one or more rules or regulations.

### BACKGROUND

As technology continues to develop to improve the ways that people can communicate with one another, nefarious parties continue to develop methods and systems for transmitting unrequested commercial advertisements via such communications. Such advertisements or messages, commonly referred to as “spam,” often account for a large amount of traffic across various communication channels. Not only can this cause problems in a communication network where the spam travels, but many spammers often use methods for distribution that utilize an entity's resources without their authorization, and distribute the spam to consumers without their consent.

In an effort to address the problem with spammers, particularly those that utilize e-mail and other electronic means for distributing spam, various laws and regulations have been passed, such as Controlling the Assault of Non-Solicited Pornography And Marketing Act of 2003 (“CAN-SPAM”) Act of 2003 (15 U.S.C. 7701, et seq., Public Law No. 108-187), for example. The CAN-SPAM Act of 2003 exposes spammers to criminal and civil liability in the United States, and makes a number of actions used to both collect address of consumers for receipt of spam and distribute of spam illegal. However, due to the overwhelming amount of spam that is distributed, as well as the in-depth techniques used by spammers, it may be difficult to accurately identify spammers or related merchants whose businesses may be at least partially driven by spam advertising.

In many instances, a spam e-mail or other electronic message, such as content published on a social network, may be an advertisement for the purchase of goods or services. These advertisements may often be accompanied by a uniform resource locator (URL) or hyperlink to a web page where the advertised goods or services may be purchased. In some cases, not only is the distribution of a spam advertisement for the goods or services illegal, but the ads for the offered goods or services may also be illegal as well, such as in the unauthorized sale of pharmaceutical drugs. As described in the article Levchenko, K.; et al. “Click Trajectories: End-to-End Analysis of the Spam Value Chain”, Security and Privacy (SP), 2011 IEEE Symposium on, May, 2011 (hereinafter “Levchenko”), which is herein incorporated by reference in its entirety, a method has been developed for identifying these offending merchants. Levchenko discloses using prepaid payment cards from a specialty issuer to conduct transactions with merchants via webpages included in received spam messages, receiving a transaction record identifying the merchant from the specialty issuer, and then identifying the merchant in the transaction record as an offending merchant.

However, this method for identifying offending merchants may suffer from one or more of a number of disadvantages. For example, the method requires the cooperation of a specialty issuer. Using multiple entities may result in a slower, less efficient system that may also require additional resources and expenditures to execute and/or maintain. In addition, there may be a risk posed by the use of the specialty issuer as the issuer may have one or more violating merchants as a customer and thus be protective of the customer and/or the data that is shared with the entity attempting to identify violating merchants. Further, the specialty issuer may be required to filter or otherwise limit the transaction data made available to the entity performing the merchant identification, which may result in inaccurate data.

Thus, there is a need for a technical solution to the problem of identifying merchants and/or acquirers who violate spam-related rules and regulations with less potential for being compromised by a third party entity.

### SUMMARY

The present disclosure provides a description of systems and methods for the associating of a merchant account with violating activity.

A method for associating a merchant account with violating activity includes: storing, in a database, a plurality of merchant profiles, wherein each merchant profile includes data related to a merchant including at least a merchant identifier; receiving, by a receiving device, a uniform resource locator or hyperlink captured from distributed electronic content that is identified as being in violation of a rule or regulation; navigating, via a browsing application program, to a webpage via the received uniform resource locator or hyperlink; initiating, by a processing device, a payment transaction for the purchase of goods or services via the webpage; receiving, by the receiving device, an authorization request for the payment transaction, wherein the authorization request includes at least a merchant identification; transmit, by a transmitting device, an authorization response in response to the received authorization request; identifying, in the database, a specific merchant profile where the included merchant identifier corresponds to the merchant identification; and indicating, in the database, the specific merchant profile as being in violation of the rule or regulation.

A system for associating a merchant account with violating activity includes a transmitting device, a database, a receiving device, and a processing device. The database is configured to store a plurality of merchant profiles, wherein each merchant profile includes data related to a merchant including at least a merchant identifier. The receiving device is configured to receive a uniform resource locator or hyperlink captured from a distributed electronic content that is identified as being in violation of a rule or regulation. The processing device is configured to: navigate, via an executed browsing application program, to a webpage via the received uniform resource locator or hyperlink; and initiate a payment transaction for the purchase of goods or services via the webpage. The receiving device is further configured to receive an authorization request for the payment transaction, wherein the authorization request includes at least a merchant identification. The transmitting device is configured to transmit an authorization response in response to the received authorization request. The processing device is further configured to: identify, in the database, a specific merchant profile where the included merchant identifier corresponds to the merchant identification; and indicate, in the database, the specific merchant profile as being in violation of the rule or regulation.

### BRIEF DESCRIPTION OF THE DRAWING FIGURES

The scope of the present disclosure is best understood from the following detailed description of exemplary embodiments when read in conjunction with the accompanying drawings.

FIG. 1 is a high level architecture illustrating a system for the identification of merchants and acquirers in violation of rules and regulations regarding the distribution of spam in accordance with exemplary embodiments.

FIG. 2 is a block diagram illustrating the processing server of FIG. 1 for the identification of merchants in violation of a rule or regulation in accordance with exemplary embodiments.

FIG. 3 is a flow diagram illustrating a process for the distribution of spam, the identification thereof, and the identification of a merchant thereby in violation of a rule or regulation in accordance with exemplary embodiments.

FIG. 4 is a flow chart illustrating an exemplary method for associating a merchant account with violating activity in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Spam—Irrelevant or inappropriate messages sent on the Internet to a large number of recipients. Spam may be distributed via e-mail, social media, newsgroups, or other suitable means as will be apparent to persons having skill in the relevant art. As discussed herein, spam may include at least one or more URLs or hyperlinks to a website or specific webpage, or an otherwise reference to said website or specific webpage, where a product may be available for purchase. Also known as junk email or unsolicited bulk email.

Controlled Payment Number—Controlled payment numbers may be payment numbers associated with a payment account that are subject to one or more rules. In many cases, these rules may be set by a cardholder, such as spending limits, limits on days and/or times of a transaction, limits on merchants or industries, transaction spending or frequency limits, etc. Controlled payment numbers may offer an account holder an opportunity to give payment cards tied to the account to others for use, but subject to rules set by the cardholder, such as an employer distributing cards to employees, or a parent distributing cards to children. Additional detail regarding controlled payment numbers may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. patent application Ser. No. 12/219,952, filed Jul. 30, 2008; U.S. patent application Ser. No. 12/268,063, filed Nov. 10, 2008; and U.S. patent application Ser. No. 12/359,971, filed Jan. 26, 2009; each of which are herein incorporated by reference in their entirety.

System for Identifying Merchants in Violation of a Rule or Regulation

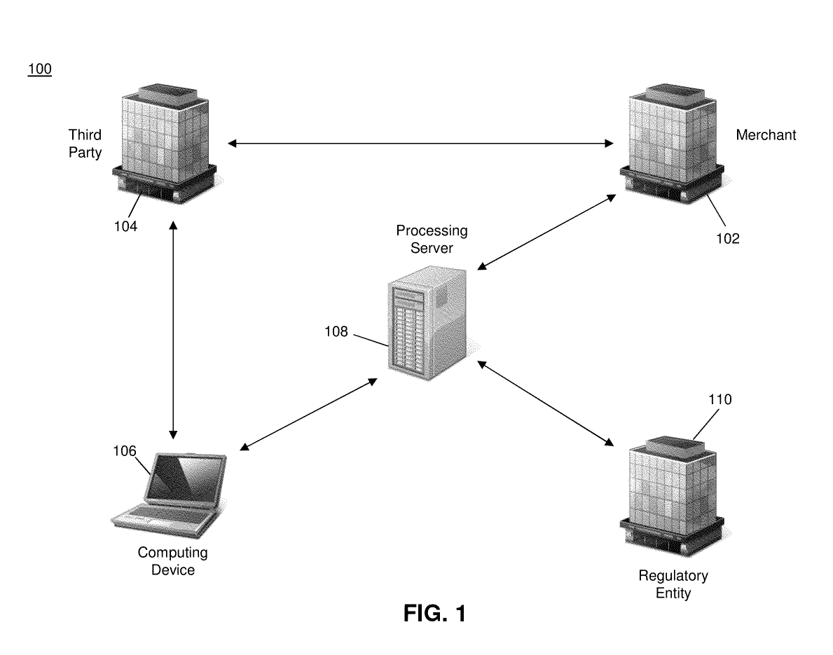

FIG. 1 illustrates a system 100 for the identification of merchants or acquirers in violation of a rule or regulation related to the distribution of spam to consumers.

The system 100 may include a merchant 102. The merchant 102 may offer one or more products (e.g., goods and/or services) available for purchase via a webpage on the Internet. It will be apparent to persons having skill in the relevant art that the webpage may be hosted by one or more third parties on behalf of the merchant 102. The system 100 may also include a third party 104. The third party 104 may be one or more entities that distribute spam advertising the webpage of the merchant 102 that has the one or more products available for purchase.

The third party 104 may distribute spam to one or more computing devices 106. The spam may be distributed via e-mail, social media (e.g., Facebook®, Twitter®, Instagram®, etc.), newsgroups, torrents, or any other suitable electronic means as will be apparent to persons having skill in the relevant art. The computing device 106 may be any type of computing device suitable for receiving the spam and performing the functions as disclosed herein, such as a desktop computer, laptop computer, notebook computer, tablet computer, cellular phone, smart phone, etc.

The computing device 106 may receive the spam from the third party 104 and forward the spam to a processing server 108. The processing server 108, discussed in more detail below, may be configured to identify the merchant 102 as associated with activity in violation of one or more rules and regulations. The rules and regulations may be issued and/or enforced by one or more regulatory entities 110. As discussed in more detail below, the processing server 108 may navigate to a webpage via URL or hyperlink included in the spam and conduct a payment transaction for a product offered by the merchant 102 via the webpage.

The processing server 108 may then receive an authorization request for the payment transaction. In some embodiments, the processing server 108 may receive the authorization request from a payment network configured to process the payment transaction. In other embodiments, the processing server 108 may operate as or be a part of a payment network and may receive the authorization request directly from the merchant 102 and/or an acquirer associated with the merchant.

The processing server 108 may then identify the merchant 102 and/or the acquirer associated with the merchant 102 based on data included in the authorization request, such as a merchant identifier (e.g., a merchant identification number). The processing server 108 may then notify the regulatory entity 110 of the merchant 102 and/or acquirer of the violating activity. The regulatory entity 110 may then take appropriate action against the merchant 102 and/or acquirer for the violation of one or more rules and regulations, such as based on the receipt of the spam by the processing server 108 and the subsequent identification of the merchant 102 and/or acquirer as being associated with the distributed spam.

As part of the processing of the payment transaction, the processing server 108 may be further configured to generate and transmit an authorization response to the payment network and/or the merchant 102. In one embodiment, the authorization response may indicate a denial of the payment transaction. In some instances, the payment transaction may be approved or denied on the basis of the one or more rules and regulations. For example, a rule or regulation may require completion of a payment transaction to identify the merchant 102 as in violation of the rule or regulation, and thus would result in the generating and transmitting of an authorization response indicating approval of the payment transaction.

In some embodiments, the authorization response may be generated without involvement by an issuer. As discussed above, not including an issuer may result in the system 100 being more efficient in both processing time and expense. In addition, the processing server 108 may be able to more accurately identify merchants 102 and/or acquirers in violation of rules and regulations without the possibility of an issuer associated with the merchant 102 intervening. Furthermore, by receiving the authorization request directly, as opposed to a transaction record that may be filtered by an issuer, the processing server 108 may be able to identify the merchant 102 more quickly and more accurately than in traditional systems.

The improved system 100 for the identification of merchants 102 in violation of the rules and regulations may be beneficial to a plurality of entities, including payment networks, merchants, retailers, service providers, and others. For example, an Internet service provider may identify received spam, but be unable to identify a source of the received spam. The Internet service provider may then forward the relevant data for the spam to the processing server 108, which may then identify the merchants 102 and acquirers associated with the spam. The Internet service provider may then take appropriate actions to defend against the spam, which may include reporting the identified merchants 102 and acquirers to the regulatory entity 110. In such an example, the Internet service provider may receive the benefit of less spam, which may improve system efficiency and expenditure of resources, without requiring modifications to existing systems.

Processing Device

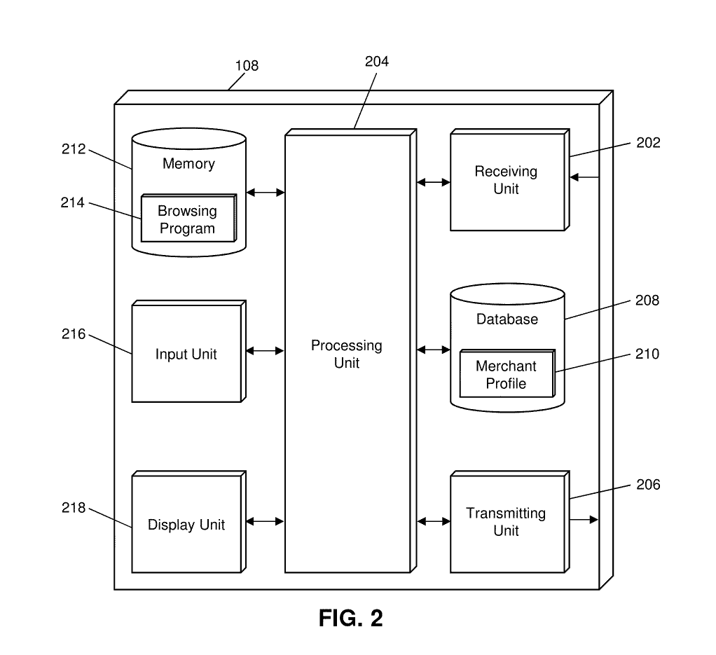

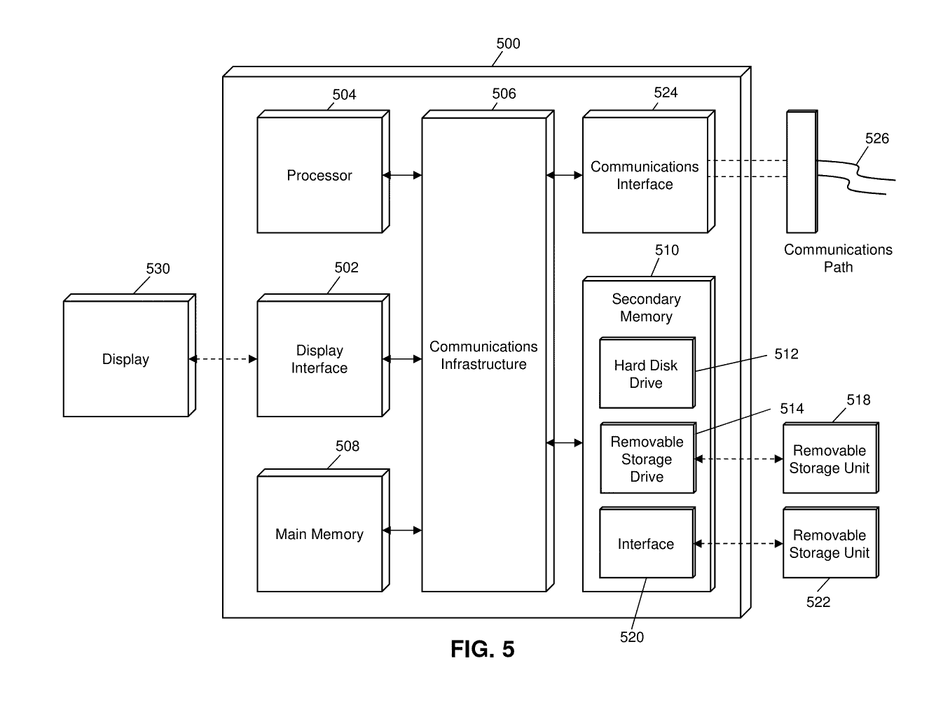

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 500 illustrated in FIG. 5 and discussed in more detail below may be a suitable configuration of the processing server 108.

The processing server 102 may include a receiving unit 202. The receiving unit 202 may be configured to receive data over one or more networks via one or more network protocols. The receiving unit 202 may be configured to receive a URL or hyperlink captured in a spam message received by the computing device 106. In some embodiments, the receiving unit 202 may receive the spam message (e.g., forward by the computing device 106). In such an embodiment, a processing unit 204 included in the processing server 108 may be configured to identify the URL or hyperlink included in the message.

The processing unit 204 of the processing server 108 may be configured to execute a browsing application program 214 included in a memory 212. The browsing application program 214 may be any type of suitable browsing program for browsing webpages on the Internet as will be apparent to persons having skill in the relevant art. The processing unit 204 may navigate to a webpage via the URL or hyperlink that was received and/or identified. The processing unit 204 may then initiate a payment transaction for the purchase of one or more products via the webpage.

In some embodiments, the payment transaction may be initiated following the receipt of one or more input commands instructing the processing unit 204 to initiate the payment transaction received via an input unit 216. The input unit 216 may be any type of input suitable for performing the functions as disclosed herein, such as a keyboard, mouse, touch screen, click wheel, microphone, camera, or other device as will be apparent to persons having skill in the relevant art. A user of the processing server 108 may view the webpage via a display unit 218 included in the processing server 108. The display unit 218 may be a liquid crystal display, light emitting diode display, cathode ray tube display, plasma display, light projection display, or any other suitable type of display as will be apparent to persons having skill in the relevant art. The user may interact with the webpage via the input unit 216 and display unit 218 to initiate the payment transaction using systems and methods that will be apparent to persons having skill in the relevant art.

The processing server 108 may further include a transmitting unit 206. The transmitting unit 206 may be configured to transmit data over one or more networks via one or more network protocols. The transmitting unit 206 may transmit data, such as payment information stored in the memory 212 and/or received via the input unit 216, over one or more networks (e.g., the Internet) to the merchant 102 for use in generating an authorization request for the initiated payment transaction. The merchant 102, or an acquirer (not shown) associated with the merchant 102, may submit the authorization request for processing. The receiving unit 202 of the processing server 108 may then receive the authorization request. In one embodiment, the authorization request may be received from a payment network. In another embodiment, the authorization request may be received directly from the merchant 102 or acquirer.

The authorization request may include at least a merchant identifier. The processing unit 204 may use the merchant identifier to identify a merchant profile 210 associated with the merchant 102 involved in the payment transaction stored in a database 208. Each merchant profile 210 stored in the database may include data related to a merchant (e.g., the merchant 102) including at least a merchant identifier associated with the related merchant. The merchant identifier may be a unique value used for identification, such as a merchant identification number (MID), registration number, routing number, point-of-sale identifier, payment account number, etc. The processing unit 204 may identify the merchant profile 210 associated with the merchant 102 where the included merchant identifier corresponds to the merchant identifier included in the authorization request.

The processing unit 204 may then store an indication in the identified merchant profile 210 of the related merchant being in violation of one or more rules or regulations. In some embodiments, the transmitting unit 206 may transmit the indication to the regulatory entity 110. The transmitting unit 206 may also transmit any additional data that may be required by the regulatory entity 110 as will be apparent to persons having skill in the relevant art.

The processing unit 204 may also be configured to generate an authorization response indicating approval or denial of the payment transaction. In some embodiments, the authorization response may indicate approval or denial based on the one or more rules or regulations issued by the regulatory entity 110. The transmitting unit 206 may then transmit the authorization response to the merchant 102 (e.g., via the payment network and/or the acquirer). In an exemplary embodiment, the processing unit 204 may generate the authorization response without involvement of an issuing financial institution. In such an embodiment, the processing server 108 may conduct the payment transaction with the merchant 102 using payment account information associated with a payment account issued to the processing server 108 (e.g., or an entity operating the processing server 108) by the issuing financial institution, and may later generate the authorization response indicating denial of the payment transaction without involvement of the issuing financial institution. Method for Identifying Merchant Activity in Violation of Rules and Regulations

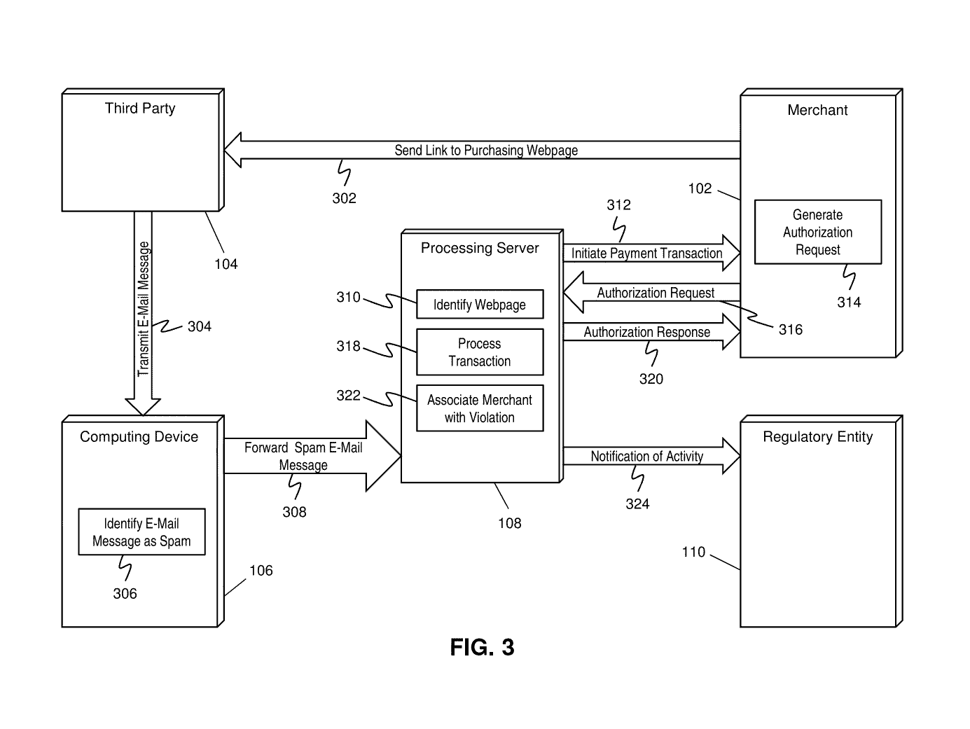

FIG. 3 illustrates a process for the distribution of spam by the third party 104 on behalf of the merchant 102 and the identification of activity by the merchant 102 as in violation of one or more rules and regulations by the processing server 108.

In step 302, the merchant 102 may send a URL or hyperlink for a webpage hosted by, or on behalf of, the merchant 102 for the purchase of goods or services to the third party 104. The third party 104 may then generate spam content, such as an e-mail message, which it may transmit to the computing device 106, in step 304. In step 306, the computing device 106 may identify the received e-mail message as spam.

Methods for identifying an e-mail message or other electronic content as spam will be apparent to persons having skill in the relevant art. In some instances, the spam may be identified as spam by being captured by monitoring an open relay for unauthorized outgoing mail. In another instance, the spam may be captured after transmission via a botnet. In yet another instance, a spam e-mail message may be captured and identified as spam via receipt of the e-mail message by an e-mail address used for the sole purposes of detecting e-mail address harvesting.

In step 308, the computing device 106 may transmit the message, identified as being spam, to the processing server 108. The processing server 108 may receive the message (e.g., via the receiving unit 202) and, in step 310, may identify a webpage associated with the message by way of an included hyperlink or URL. In some instances, the processing server 108 may navigate (e.g., via the browsing program 214) to a first webpage via the URL or hyperlink included in the spam and then be directed to a second webpage, which may be identified as the webpage for purchasing one or more products.

In step 312, the processing server 108 may initiate a payment transaction with the merchant 102 for the purchase of one or more products via the identified webpage. The initiation of the payment transaction may include transmitting (e.g., via the transmitting unit 206) payment information to the merchant 102. In step 314, the merchant 102 (e.g., or an acquirer associated with the merchant 102) may generate an authorization request for the payment transaction. The authorization request may include at least a merchant identifier associated with the merchant 102. In step 316, the authorization request may be submitted to the processing server 108 (e.g., via a payment network) from the merchant 102 and/or the associated acquirer.

In step 318, the processing server 108 may process the payment transaction using methods and systems that will be apparent to persons having skill in the relevant art. In some embodiments, the processing server 108 may generate an authorization response for the payment transaction without involving an issuer of the payment account corresponding to the payment information transmitted to the merchant 102 in step 312. Following the processing of the payment transaction, the processing server 108 may transmit an authorization response to the merchant 102, in step 320.

In some embodiments, the processing server 108 may utilize a controlled payment number for use in the payment transaction. In some instances, the controlled payment number may be configured for use in a single payment transaction. Use of controlled payment numbers may enable the processing server 108 to initiate transactions via controlled payment numbers associated with one or more payment accounts such that a limited number of payment accounts (e.g., a single payment account) may be used to conduct payment transactions. Use of unique controlled payment numbers of each transactions may enable the processing server 108 to easily identify which merchant 102 is associated to which transaction based on the controlled payment number used for the respective transaction. Controlled payment numbers may thus enable the processing server 108 to quickly and efficiently keep track of transactions and authorizations, without the need for multiple payment accounts.

In step 322, the processing server 108 may identify a merchant profile 210 in the database 208 based on the merchant identifier included in the authorization request and may associate the merchant 102 as being in violation of one or more rules and regulations. In step 324, the processing server 108 may transmit a notification of the violating activity by the merchant 102 (e.g., including the spam message and the transaction information) to the regulatory entity 110. The regulatory entity 110 may then act on the information provided by the processing server 108 as they see fit.

Method for Associating a Merchant Account with Violating Activity

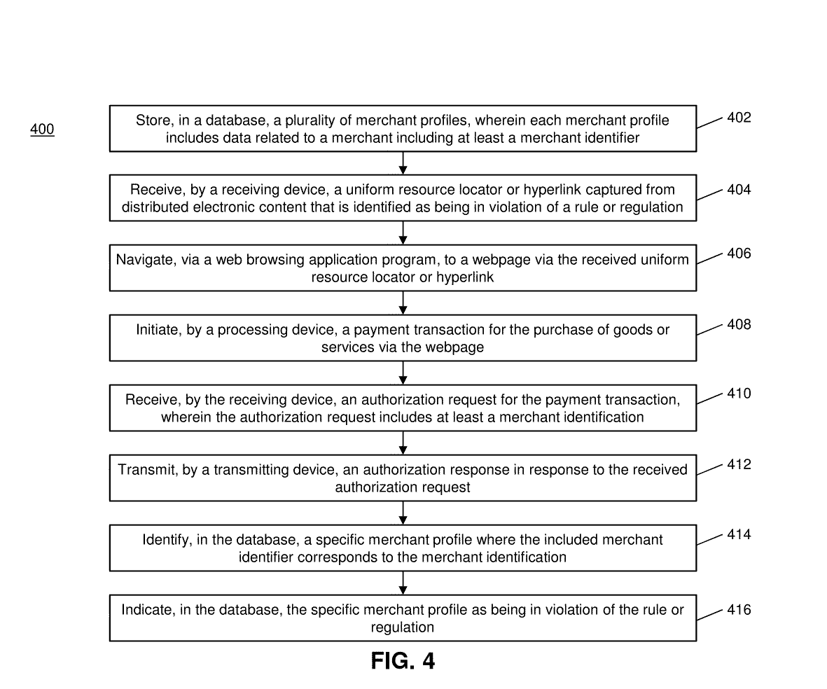

FIG. 4 illustrates a method 400 for the associating of a merchant 102 payment account or profile with activity in violation of one or more rules or activities.

In step 402, a plurality of merchant profiles (e.g., the merchant profiles 210) may be stored in a database (e.g., the database 208), wherein each merchant profile 210 includes data related to a merchant (e.g., the merchant 102) including at least a merchant identifier.

In step 404, a uniform resource locator (URL) or hyperlink may be captured from distributed electronic content that is identified as being in violation of a rule or regulation. In one embodiment, the rule or regulation may be the CAN-SPAM Act of 2003. In some embodiments, the distributed electronic content that is identified as being in violation of a rule or regulation may be captured by a third party (e.g., the computing device 106) and may be transmitted to the third party via a botnet. In other embodiments, the distributed electronic content that is identified as being in violation of a rule or regulation may be an e-mail captured by monitoring an open relay for unauthorized outgoing mail. In yet another embodiment, the distributed electronic content that is identified as being in violation of a rule or regulation may be an e-mail captured via an e-mail address used for the sole purpose of detecting e-mail address harvesting.

In step 406, a processing device (e.g., the processing unit 204) may navigate, via a web browsing application program (e.g., the browsing program 214) to a webpage via the received URL or hyperlink. In one embodiment, navigating to the webpage via the received URL or hyperlink may include navigating to a first website corresponding to the received URL or hyperlink and being redirected to a second website corresponding to a second URL or hyperlink, wherein the webpage is the second website. In step 408, a payment transaction for the purchase of goods or services may be initiated, by the processing unit 204, via the webpage. In one embodiment, initiating the payment transaction may include: identifying, by the processing unit 204, a controlled payment number configured for use in a single payment transaction; and transmitting, by a transmitting device (e.g., the transmitting unit 206), the controlled payment number for use in funding the payment transaction.

In step 410, an authorization request for the payment transaction may be received, by the receiving unit 202, wherein the authorization request includes at least a merchant identification. In one embodiment, the method 400 may further include identifying, by the processing device, a controlled payment number configured for use in a single payment transaction, wherein the authorization request includes the identified controlled payment number. In step 412, an authorization response may be transmitted, by a transmitting device (e.g., the transmitting unit 206) in response to the received authorization request. In one embodiment, the method 400 may further include: processing, by the processing unit 204, the payment transaction to generate the authorization response prior to transmission of the authorization response. In a further embodiment, the authorization response may be a network-authorization response and may be generated without involving of an issuing financial institution.

In step 414, a specific merchant profile 210 may be identified, in the database 208, where the included merchant identifier corresponds to the merchant identification. In step 416, the processing unit 204 may indicate, in the database 208, the specific merchant profile 210 as being in violation of the rule or regulation. In one embodiment, the authorization request may be received from an acquirer, and the method 400 may further include: indicating, by the processing unit 204, the acquirer as being in violation of the rule or regulation. In some embodiments, the method 400 may further include transmitting, by the transmitting device 206, a notification, to an entity associated with the rule or regulation (e.g., the regulating entity 110), indicating violation of the rule or regulation by a merchant (e.g., the merchant 102) associated with the specific merchant profile 210.

Computer System Architecture

FIG. 5 illustrates a computer system 500 in which embodiments of the present disclosure, or portions thereof, may be implemented as computer-readable code. For example, the processing server 108 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive, the removable storage unit 518 may be a floppy disk. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

Techniques consistent with the present disclosure provide, among other features, systems and methods for associating a merchant account with violating activity. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for associating a merchant account with violating activity, comprising:
storing, in a database, a plurality of merchant profiles, wherein each merchant profile includes data related to a merchant including at least a merchant identifier;
receiving, by a receiving device, a uniform resource locator or hyperlink captured from distributed electronic content that is identified as being in violation of a rule or regulation;
navigating, via a browsing application program, to a webpage via the received uniform resource locator or hyperlink;
initiating, by a processing device, a payment transaction for the purchase of goods or services via the webpage;
receiving, by the receiving device, an authorization request for the payment transaction, wherein the authorization request includes at least a merchant identification;
transmit, by a transmitting device, an authorization response in response to the received authorization request;
identifying, in the database, a specific merchant profile where the included merchant identifier corresponds to the merchant identification; and
indicating, in the database, the specific merchant profile as being in violation of the rule or regulation.

2. The method of claim 1, wherein the rule or regulation is the CAN-SPAM Act of 2003.

3. The method of claim 1, further comprising:
processing, by the processing device, the payment transaction to generate the authorization response prior to transmission of the authorization response.

4. The method of claim 3, wherein the authorization response is a network-authorization response and is generated without involvement of an issuing financial institution.

5. The method of claim 1, wherein the distributed electronic content that is identified as being in violation of a rule or regulation is an e-mail captured by monitoring an open relay for unauthorized outgoing mail.

6. The method of claim 1, wherein the distributed electronic content that is identified as being in violation of a rule or regulation is captured by a third party and was transmitted to the third party via a botnet.

7. The method of claim 1, wherein the distributed electronic content that is identified as being in violation of a rule or regulation is an e-mail captured via an e-mail address used for the sole purpose of detecting distributed e-mail harvesting.

8. The method of claim 1, wherein navigating to the webpage via the received uniform resource locator or hyperlink includes navigating to a first website corresponding to the received uniform resource locator or hyperlink, and being redirected to a second website corresponding to a second uniform resource locator or hyperlink, wherein the webpage is the second website.

9. The method of claim 1, wherein the authorization request is received from an acquirer, and wherein the method further includes:
indicating, by the processing device, the acquirer as being in violation of the rule or regulation.

10. The method of claim 1, wherein initiating the payment transaction includes:
identifying, by the processing device, a controlled payment number configured for use in a single payment transaction, and
transmitting, by the transmitting device, the controlled payment number for use in funding the payment transaction.

11. The method of claim 1, further comprising:
identifying, by the processing device, a controlled payment number configured for use in a single payment transaction,
wherein the authorization request includes the identified controlled payment number.

12. The method of claim 1, further comprising:
transmitting, by the transmitting device, a notification, to an entity associated with the rule or regulation, indicating violation of the rule or regulation by a merchant associated with the specific merchant profile.

13. A system for associating a merchant account with violating activity, comprising:
a transmitting device;
a database configured to store a plurality of merchant profiles, wherein each merchant profile includes data related to a merchant including at least a merchant identifier;
a receiving device configured to receive a uniform resource locator or hyperlink captured from an distributed electronic content that is identified as being in violation of a rule or regulation; and
a processing device configured to
navigate, via an executed browsing application program, to a webpage via the received uniform resource locator or hyperlink, and
initiate a payment transaction for the purchase of goods or services via the webpage, wherein
the receiving device is further configured to receive an authorization request for the payment transaction, wherein the authorization request includes at least a merchant identification,
the transmitting device is configured to transmit an authorization response in response to the received authorization request, and
the processing device is further configured to
identify, in the database, a specific merchant profile where the included merchant identifier corresponds to the merchant identification, and
indicate, in the database, the specific merchant profile as being in violation of the rule or regulation.

14. The system of claim 13, wherein the rule or regulation is the CAN-SPAM Act of 2003.

15. The system of claim 13, wherein the processing device is further configured to process the payment transaction to generate the authorization response prior to transmission of the authorization response.

16. The system of claim 15, wherein the authorization response is a network-authorization response and is generated without involvement of an issuing financial institution.

17. The system of claim 13, wherein the distributed electronic content that is identified as being in violation of a rule or regulation is an e-mail captured by monitoring an open relay for unauthorized outgoing mail.

18. The system of claim 13, wherein the distributed electronic content that is identified as being in violation of a rule or regulation is an e-mail captured by a third party and was transmitted to the third party via a botnet.

19. The system of claim 13, wherein the distributed electronic content that is identified as being in violation of a rule or regulation is captured via an e-mail address used for the sole purpose of detecting e-mail address harvesting.

20. The system of claim 13, wherein navigating to the webpage via the received uniform resource locator or hyperlink includes navigating to a first website corresponding to the received uniform resource locator or hyperlink, and being redirected to a second website corresponding to a second uniform resource locator or hyperlink, wherein the webpage is the second website.

21. The system of claim 13, wherein the authorization request is received from an acquirer, and
the processing device is further configured to indicate the acquirer as being in violation of the rule or regulation.

22. The system of claim 13, wherein initiating the payment transaction includes:
identifying, by the processing device, a controlled payment number configured for use in a single payment transaction, and
transmitting, by a transmitting device, the controlled payment number for use in funding the payment transaction.

23. The system of claim 13, wherein
the processing device is further configured to identify a controlled payment number configured for use in a single payment transaction, and
the authorization request includes the identified controlled payment number.

24. The system of claim 13, further comprising:
a transmitting device configured to transmit a notification, to an entity associated with the rule or regulation, indicating violation of the rule or regulation by a merchant associated with the specific merchant profile.
